(19) United States
(12) Patent Application Publication
(10) Pub. No.: US 2026/0136074 A1
(43) Pub. Date: May 14, 2026

(54) Digital Display Device Allowing A Remote Interruption Of A Content Diffusion

(71) Applicant: JCDecaux SE, NEUILLY SUR SEINE (FR)

(72) Inventors: Timmy FLOUME, BAGNOLET (FR); Frédéric CHANSON, CARRIERES SOUS POISSY (FR); Ludovic BERTRAND, BREVAL (FR)

(73) Assignee: JCDecaux SE, NEUILLY SUR SEINE (FR)

(21) Appl. No.: 19/119,246

(22) PCT Filed: Sep. 25, 2023
(86) PCT No.: PCT/EP2023/076416

§ 371 Date: Apr. 8, 2025

(30) Foreign Application Priority Data
Oct. 12, 2022 (FR) FR2210477

(51) Int. Cl. H04N 21/488; G06F 21/55; H04N 21/414; H04N 21/462; H04N 21/6543

(52) U.S. Cl. CPC H04N 21/4882; G06F 21/554; H04N 21/41415; H04N 21/4622; H04N 21/6543; G06F 2221/034

(57) ABSTRACT

A digital display device comprising:
a digital screen;
a first receiver able to receive a first content via a first communication channel;
a second receiver able to receive a message via a second communication channel;
a first player able to play on the digital screen the first content received via the first communication channel;
   a switch configured for deactivating playing of the first content by the first player, upon receiving the message via the second receiver.

### FIELD OF THE INVENTION

The present disclosure belongs to the field of digital screens. More specifically, it belongs to from the field of digital display device control.

### DESCRIPTION OF RELATED ART

Digital display devices are devices with which to broadcast digital content. The digital content may for example include advertisements, but also information and awareness campaigns.

The digital display devices may for example come in the form of large screens arranged in public spaces, for example in subway stations, on the storefronts of buildings or incorporated in shelters for travelers.

The digital display devices are particularly useful for widely broadcasting content campaigns, for example advertising or awareness campaigns. Modern digital display devices are generally linked to the infrastructure of an operator by a high-speed connection, for example a fiber, 4G or 5G connection over which the operator may send the content and the instructions for playing the content.

The content may for example comprise images, text and video, and instructions for playing the content. A digital display device thus typically comprises a playlist defining the content displayed by the display device during successive timeslots.

While digital display devices provide a particularly attractive solution for widely broadcasting content, it may happen that the channel for receiving content by the display device is corrupted, which may allow individuals with bad intentions to broadcast malicious or inappropriate content.

This situation is even more harmful when the corruption of the channel for receiving the content may prevent the operator from sending corrective messages by this channel. It may then be necessary to send a technician to travel to the site for manually restarting the digital screen. This operation is however long and costly and may delay stopping the broadcast of malicious messages.

One solution for this problem may consist of making the channel for receiving the content more reliable, for example by encrypting the communication. However, it is difficult to make the communication channel totally inviolable, and that does not eliminate the need to make use of manual operations in case of corruption of the communication channel.

There is therefore a need for a digital display device with which to automatically stop the broadcast of malicious content, in case of corruption of the communication channel over which the content is typically received.

Another problem encountered by digital display devices from the state-of-the-art is that they receive content only by their operator. They can therefore not be used for broadcasting more global messages, for example broadcasting emergency messages broadcast by authorities other than the operator of the device.

There is therefore also a need for a display device able to broadcast emergency messages broadcast by authorities other than the operator of the device.

### BRIEF SUMMARY OF THE INVENTION

The present disclosure aims to improve the situation.

It is proposed a digital display device comprising: at least one digital screen; at least one first receiver able to receive at least one first content via a first communication channel; at least one second receiver, distinct from the at least one first receiver, able to receive at least one message via a second communication channel, distinct from the first communication channel; a first player able to play on at least one digital screen the at least one first content received via the first communication channel; a switch configured for deactivating playing of the at least one first content by the first player, upon receiving a message by the at least one second receiver.

“Receiver” is understood to mean a module able to receive information by a communication channel. If the communication channel is a radio communication channel, the receiver may for example comprise an antenna and a decoder. If the communication channel is a wire or optical fiber type communication channel, the receiver may comprise a converter for the signals received by the wire or optical fiber communication, and a decoder.

“Communication channel” is understood to mean a set of elements allowing communication between two terminals. For example, the communication channel may be a wired communication channel such as optical fiber or ADSL network, or a wireless communication channel such as a 4G, 5G, Lora or satellite connection.

This allows remotely stopping broadcast of malicious or inappropriate content received via the first communication channel. Further, stopping the broadcast of the malicious content may be done almost instantaneously, even if the first communication channel is corrupted. This also allows an authority other than the device operator to stop the broadcast of the first content for broadcasting emergency messages in its place.

According to another aspect, a management system is proposed for a device comprising: the display device according to one of the embodiments from the present disclosure; infrastructure for the operator of the display device in communication with the display device via the first communication channel; a platform, in communication with the display device via the second communication channel.

According to another aspect, it is proposed a process for control of a digital display device comprising: receiving, by at least one receiver of the device, at least one first content via a first communication channel; playing, by a first player of the device, at least one first content on at least one digital screen of the device; receiving, by at least one second receiver of the device, distinct from the at least one first receiver, at least one message via a second communication channel, distinct from the first communication channel; upon receiving the at least one message, deactivating, by a switch of the device, the playing of the at least one first content by the first player.

According to another aspect, a computer program is proposed comprising instructions for implementing the process according to one of the embodiments from the disclosure.

According to another aspect, a nonvolatile, computer-readable recording medium is proposed on which is stored a program for use by the process according to one of the embodiments of the disclosure when this program is executed by a processor.

According to another aspect, a computer program is proposed comprising instructions for implementing all or part of a process such as described in the present when this program is executed by a processor.

According to another aspect, a nonvolatile, computer-readable recording medium is proposed on which such a program is recorded.

The features disclosed in the following paragraphs may, optionally, be implemented independently of each other or in combination with each other:

Advantageously, the device comprises a second player able to display on the digital screen a message received by the at least one second receiver or a second content associated with the message received by the second receiver, and wherein the switch is configured for activating the playing by the second player upon receiving the message.

This makes it possible to broadcast a replacement content even in case of corruption of the first player, and therefore to improve the security of the device. This also makes it possible to place a player specifically suited to playing the content connected to the message.

Advantageously, the device comprises at least one first processing unit for implementing the first player and the first receiver; at least one second processing unit, distinct from the at least one first processing unit, for implementing the second receiver and the switch.

“Processing unit” is understood to mean an electronic component able to execute electronic or computer calculations for executing a set function. A processing unit may designate any type of electronic processor or component able to execute digital calculations. For example, a processing unit may be an integrated circuit, an ASIC (“Application Specific Integrated Circuit”), a microcontroller, a microprocessor, a DSP (“Digital Signal Processor”), a processor, and a GPU (“Graphics Processing Unit”). A processing unit according to the invention is not limited to a particular type of processing architecture. For example, a processor may implement a Harvard or von Neumann type architecture.

This makes it possible to further improve the security of the digital image broadcast device, because, in case of corruption of the first communication channel and/or the first player, the deactivation of the playing of the first content is done by a processing unit totally independent of the first receiver and the first player.

Advantageously, the switch is a software module incorporated in the first player.

This makes it possible to implement a simple and flexible architecture.

Advantageously, the first or second player is configured for playing a second content associated with the message.

Playing a content associated with the message serves to broadcast without delay a message of interest, for example an emergency message of interest to the entire population, or a message related to stopping the broadcast of malicious messages.

Advantageously, the first or the second player is configured for converting a text content of the message into a video representing the content of the message, and playing the video on the screen.

The conversion of the text content of the message into video content to be displayed advantageously allows benefiting from a video rendering immediately capturing the attention of those passing by, while only having a very light text message to be transmitted, which makes it possible for example to broadcast the message very quickly, to avoid the loss of the message or to send the message by low bitrate networks.

Advantageously, the second receiver is configured for receiving the second content associated with the message, and the first or second player is configured for playing the second content on the screen.

This allows instantaneously replacing the playing of the first content by the second content.

Advantageously, the first communication channel is a high-speed connection with an infrastructure of the operator of the display device, and the at least one first content comprises the video content.

“High-speed connection” is understood to mean a connection allowing a significant data rate, like for example a Wi-Fi, 4G or 5G connection.

This makes it possible to receive and broadcast standard high-volume content, for example videos. This also makes possible rapid changes of the standard content to be broadcast.

Advantageously, the second communication channel comprises a long-distance radio connection.

This makes it possible for the display device to receive messages from remote platforms via the second communication channel.

Advantageously, the second receiver is in local communication with a satellite receiver.

This makes it possible to benefit from a satellite connection even when the display device itself is located in a place blocking it from receiving satellite signals.

Advantageously, the second communication channel comprises a low-rate radio connection.

“Low-rate radio connection” is understood to mean a radio connection able to transmit messages only at a reduced rate, such as, for example, SMS or Lora connections.

This makes it possible for the device to receive messages by reliable connections including over long distances, and to benefit from existing networks providing message transmission over long distances.

Advantageously, the second communication channel is a communication channel with an emergency management platform configured for sending an emergency message to the second receiver via the second communication channel in case of a catastrophic event.

“Platform” is understood to mean an infrastructure dedicated to a given task involving communication with remote devices. A platform may for example comprise computers, servers, storage, etc. with which to send messages to the display device should a given event occur.

This makes it possible for the emergency management platform to widely broadcast emergency messages to all the digital display devices of several operators, and therefore to widely and rapidly broadcast emergency messages to the population. This makes it possible to quickly react, nationally or regionally, to catastrophic events.

Advantageously, the second communication channel is a communication channel with a platform configured for sending a stop message to the second receiver via the second communication channel on detection of the corruption of the display device.

This makes it possible to stop without delay the broadcast of malicious messages on the display device, once the corruption of the first player and/or the first communication channel is detected. This considerably improves the security of the digital display device.

### BRIEF DESCRIPTION OF THE DRAWINGS

Other features, details and advantages will appear upon reading of the following detailed description, and analysis of the attached drawings, on which:

FIG. 1 shows an example of security architecture within which the invention may be implemented.

FIG. 2 shows an example of architecture for detection and stopping of malicious messages within which the invention may be implemented.

FIG. 3a shows a first example of a digital display device according to a set of embodiments of the invention.

FIG. 3b shows a second example of a digital display device according to a set of embodiments of the invention.

FIG. 4 shows an example of receiving satellite signals by indoor digital display devices according to an embodiment.

FIG. 5 shows an example of local detection of corrupted digital display devices according to an embodiment.

FIG. 6 shows an example of a method according to an embodiment.

### DESCRIPTION OF EMBODIMENTS

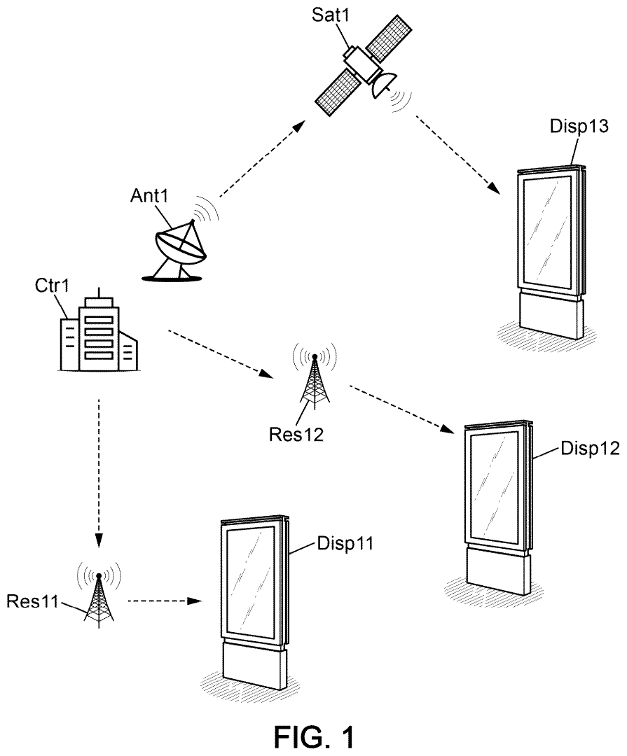

It is now referred to FIG. 1.

FIG. 1 shows an example security architecture within which the invention may be implemented.

In the architecture shown in FIG. 1, an emergency management center Ctr1 detects catastrophic events which could be human attacks (for example terrorist attacks) or natural catastrophes (for example, flooding, forest fires, etc.) and sends information and/or instruction messages to the population upon detecting a catastrophe.

The emergency management center Ctr1 may for example be a national or regional center.

One of the channels used by the center Ctr1 for sending messages to the population comprises digital display devices such as advertising panels. This type of device has the advantage of being present in many areas where people often gather (train stations, shelters for travelers, shopping centers, etc.) and of generally having a very high visibility.

In the example from FIG. 1, three digital display devices Disp11, Disp12 and Disp13 are shown.

On the occurrence of a catastrophic event, the center Ctr1 is configured for sending a message simultaneously to the largest possible number of digital display devices. Sending the message may be done in various ways. In the example from FIG. 1, a message may be sent:
to the device Disp11 through a mobile network (SMS, 4G, 5G, etc.) Res11;
to the device Disp12 through a low-speed and long-distance network Res12 (for example a Lora type network) Res12;
to the device Disp13 by an antenna Ant1 and a satellite Sat1.

Each of these modes of transmission has its advantages. For example, the mobile network Res11 is generally widely developed, the low-speed and long-distance network Res12 makes it possible to send messages long distances, including into zones poorly served by conventional mobile networks, and transmitting by satellite Sat1 serves to reach all of the territory.

These examples of transmission networks are however given solely as nonlimiting examples. According to the invention, any type of network able to send a message from the center Ctr1 to a digital display device may be used.

Upon receiving the emergency message, each of the devices Disp11, Disp12 and Disp13 is configured for stopping the broadcast of the content underway, for example the current publicity campaign, for broadcasting the emergency message sent by the center Ctr1.

This architecture therefore makes it possible to quickly and widely broadcast emergency messages to the population, and therefore to quickly react to catastrophic events.

The emergency message may in some cases be accompanied by content to be broadcast, for example a video giving information about the current catastrophe and instructions concerning for example the precautions to take for safety. In this case, the devices Disp11, Disp12 and Disp13 may be configured for broadcasting the content associated with the emergency message.

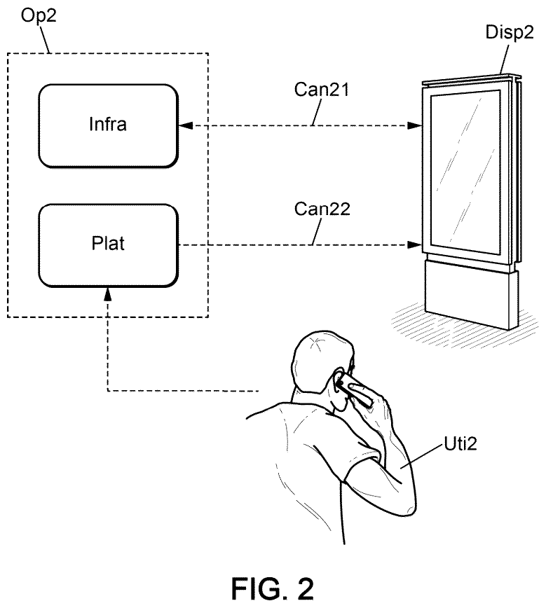

It is now referred to FIG. 2.

FIG. 2 shows an example of security architecture within which the invention may be implemented.

In the example from FIG. 2, one digital display device Disp2 is managed by an operator Op2. The operator Op2 comprises an infrastructure Infra configured for sending at least one first content to be displayed on the device Disp2 through a first communication channel Can21. For example, the infrastructure Infra may be an infrastructure for broadcasting advertising campaigns, and sending advertisements to display on the device Disp2. The first communication channel Can21 may for example comprise optical fiber, Wi-Fi, a high-speed mobile network, etc.

In some cases, the first channel Can21 may be pirated or corrupted, meaning that a malicious individual may compromise the channel Can21 for displaying malicious content on the device Disp2. Malicious content may in general be content not intended by the operator Op2. It may for example involve content with a pornographic, hateful, deceitful, or discriminatory content, or more generally content not approved by the operator op2.

The broadcast of the malicious content may be detected in various ways. For example, the first channel Can21 may make it possible for the device Disp2 to send return messages, or broadcast reports, to the infrastructure Infra. If there is no message or an incoherent message, a corruption of the first communication channel Can21 may be detected.

The broadcast of the malicious content may also be detected by a user Uti2 who, passing in front of the device Disp2, observes the broadcast of malicious content and alerts the operator.

On detecting the malicious content, a security platform Plat of the operator sends, through a second communication channel Can22, a stop message to the device Disp2. On receiving the stop message, the device Disp2 immediately stops broadcasting the malicious content. The device Disp2 may also display text or video content associated with the stop message instead of the malicious content.

Sending a stop message by a second channel Can22 distinct from the first channel Can21 thus makes it possible to immediately stop broadcasting malicious content, even if the first channel Can21 is unusable by the operator Op2 because of corruption.

We are now going to study in more detail the structure of the digital display device in a set of embodiments of the invention.

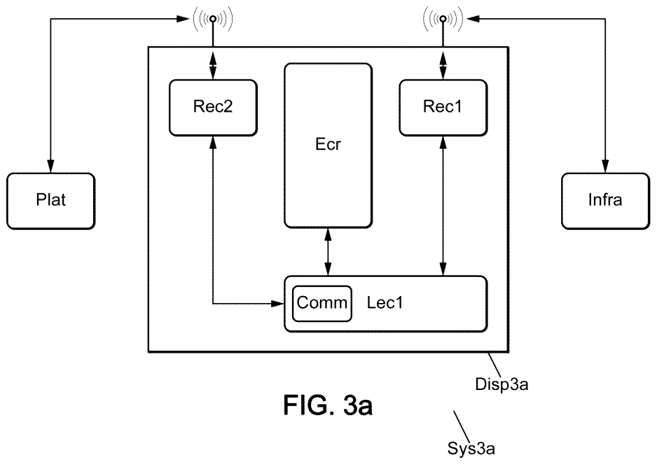

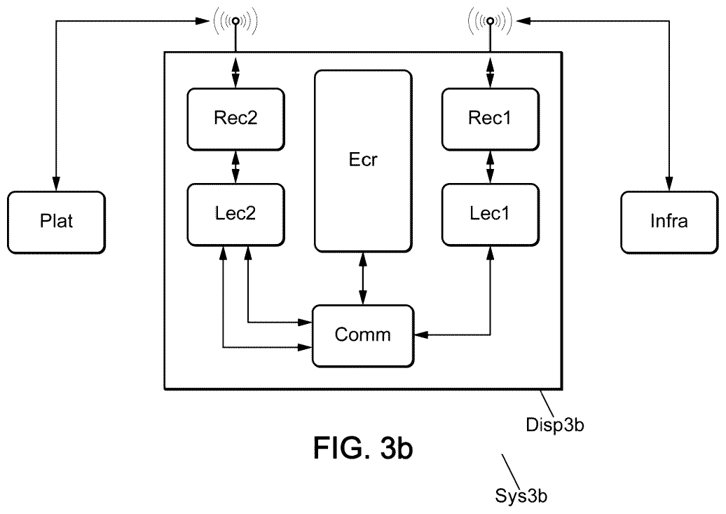

It is now referred to FIG. 3a.

FIG. 3a shows an example of a digital display device Disp3a according to a set of embodiments of the invention.

The digital display device Disp3a is a device able to display digital content. It may for example involve an advertising display device, with which to display advertising campaigns, but also information or awareness campaigns, and/or messages that are useful to the public.

The digital display device Disp3a may thus be for example placed on the fronts of buildings, in train stations, commercial centers, subway stations, on shelters for travelers, etc. The digital display device Disp3a may generally be placed in any public or private space in which it may be seen by people passing by.

The digital display device Disp3a comprises at least one screen Ecr. The at least one screen Ecr is able to display text, images and video. The digital display device Disp3a may also comprise one or more speakers with which to broadcast soundtracks, for example when playing a video.

The digital display device also comprises a first receiver Rec1 able to receive at least one first content by a first communication channel.

The first content may be a standard content. “Standard content” is understood to mean a content usually broadcast by the digital display device. The standard content may, for example, come in the form of images, text or videos.

As indicated above, standard content corresponds to a content usually broadcast by the digital display device such as:
an advertising campaign;
an information campaign;
etc.

The first content may come in the form of various types of media, such as text, images or video.

The first communication channel may be of various types. It may in particular involve a high-speed connection with an infrastructure Infra the operator of the display device.

The infrastructure Infra may in particular be the central infrastructure of the operator of the display device, which makes it possible to broadcast the content to various display devices, and giving instructions for broadcasting the content. The infrastructure may for example comprise computers, servers, storage, etc. with which to store and send digital content.

The use of a high-speed connection, such as a 4G, 5G, ADSL or fiber-optic connection makes it possible to both broadcast the standard high-volume content, but also to quickly change the standard content to be sent.

The display device Disp3a also comprises a first player Lec1 able to play on the at least one digital screen the at least one first content received via the first communication channel.

The player Lec1 thus makes it possible to broadcast the standard content on the screen. The player Lec1 may directly play the first content, for example a video, or modify it in order to play it. For example, the player Lec1 may modify the content to adapt it to the screen, for example by resizing a video that is too large to be played on the screen, adjusting the brightness of several successive videos, etc.

The player Lec1 may define a playlist for the content to be played. For example, the at least one first content received by the first receiver may be progressively incorporated in a playlist, and the first player Lec1 may successively play the tracks from the list. The management of the playback of the list may be done in various ways. For example, the first player Lec1 may associate play times, or percentages of play times, with each of the tracks on the list. The tracks played may also be broadcast preferentially at some times (hours/days, etc.) in order to adapt to the people moving in front of the digital display device.

The first receiver and the first player therefore make it possible to broadcast at least one first content sent by the operator of the digital display device.

However, the first communication channel may be corrupted. For example, an individual with bad intentions may corrupt the communication channel for broadcasting malicious messages. In this case, it may be impossible for the operator of the display device to reestablish the situation via the first communication channel, because it is corrupted.

Nor does the first channel allow an authority other than the operator of the display device to display messages on the device. For example, the first communication channel may not allow an emergency management center such as the center Ctr1 shown in FIG. 1 to send emergency messages to the device Disp3a.

In order to overcome these problems, the device Disp3a also comprises:
at least one second receiver Rec2 able to receive at least one message via a second communication channel;
a switch Comm configured for deactivating playing of the at least one first content by the first player, upon receiving a message via the at least one second receiver.

In that way, upon receiving the message via the second communication channel, the current display is immediately interrupted without needing to make use of the first communication channel.

The second communication channel may be a communication channel with a platform Plat, which may for example be a platform of the operator of the device, or a platform of a national or regional authority.

For example, the platform Plat may be a platform of the operator configured for sending a stop message to the second receiver via the second communication channel on detection of the corruption of the display device.

This makes it possible for example for the operator of the display device to send a stop message to the display device once the corruption thereof is detected, and therefore to stop without delay the broadcast of malicious messages. Further, since the second communication channel is distinct from the first communication channel, corruption of the first communication channel does not affect the possibility of receiving the stop message via the second communication channel. Broadcasting malicious messages may therefore be stopped upon detection thereof.

As indicated with reference to FIG. 2, the detection of the broadcasting of malicious messages may be done in various ways:
the digital display device may be configured for sending broadcast reports to the infrastructure of the operator, via the first or second communication channels. Should the absence of a report or a report different from the expected report be detected, a stop message may be sent to the display device via the second channel;
the broadcast of malicious or inappropriate content may be detected by users passing in front of the display device, who alert the operator of the display device about it;
etc.

In that way, the broadcast of malicious content is stopped upon detection, even if the first communication channel is corrupted and unusable by the operator of the display device, which allows considerably improving the security of the digital display device.

The platform Plat may also be an emergency management platform configured for sending an emergency message to the second receiver via the second communication channel in case of a catastrophic event.

In this case, the platform Plat may for example be a national or regional platform sending emergency messages. For example, it may involve a platform sending messages in case of attack (terrorism, bacteriological alert, etc.), industrial catastrophe, or natural catastrophe (earthquake, flooding, etc.).

Whatever the origin of the message received via the second communication channel, the first player may be configured, not only for stopping playing the first content, but also for reading a content associated with the message received via the second communication channel.

If this message is an emergency message, playing the content associated with the emergency message makes it possible for the emergency management platform to widely broadcast emergency messages to all the digital display devices of several operators, and therefore to widely and rapidly broadcast emergency messages to the population. This makes it possible to quickly react, nationally or regionally, to catastrophic events.

If the message is a message to stop broadcasting a malicious content, the playing of the content associated with the stop message makes it possible for example to broadcast a message indicating that the display device is temporarily unavailable and will be repaired as soon as possible, or any other message relating to stopping the broadcast of the malicious content.

Playing the content associated with the message received via the second communication channel may simply consist of a display of the text content of the message.

The text content of the message may also be converted into video content to be displayed on the screen.

For example, the text content of the message may be analyzed by the first player, and converted into video visually representing the content. For example, if the message is an emergency message announcing an imminent flood, a video showing a flood may be broadcast, accompanied by a text message indicating that a flood is imminent, and asking the population to take shelter. Such a video may for example be automatically generated by the first player, or retrieved from a library of videos incorporated in the display device representing various possible alert messages.

For example, the digital display device may comprise a library of videos corresponding to various alert messages, where the videos are associated with tags. For example, a video may comprise tags related to the message type (for example #terrorism, #flooding, etc.), but also other characteristics of the video such as the location (#city, #mountain, etc.), season (#winter, #summer, etc.), etc. The text content of the message may thus comprise one or more tags corresponding to the type of video to play, and the video may be selected by the display device based on the associated tags. In that way, the tags make it possible to select the most appropriate video both as a function of the content (message type) and the context (broadcast environment).

The conversion of the text content of the message into video content to be displayed advantageously allows benefiting from a video rendering immediately capturing the attention of those passing by, all while only requiring transmission of a small size message, which serves for example broadcasting messages very quickly, avoiding the loss of the message or sending the message by low rate networks.

The second receiver may also be configured for receiving content associated with the message. For example, the platform Plat may send, in parallel with the message, video content which will be played by the first player, potentially in parallel with the broadcast of a text content from the message.

In that way, stopping the broadcast of the first content may be instantaneously replaced by the display on the screen Ecr of the second content associated with the message. For example, in case of a catastrophe, the second content may contain information or instructions given to the population. In that way, informational or instructional messages in case of catastrophe may be widely broadcast.

The second communication channel may be of various types.

For example, it may comprise a long-distance radio connection, for example radio communication using relay antennas, according to the Lora standard, or by satellite.

A satellite connection has in particular the advantage of being able to widely broadcast emergency or alert messages over a territory.

In case of a satellite connection, the second receiver may be in local communication with a satellite receiver.

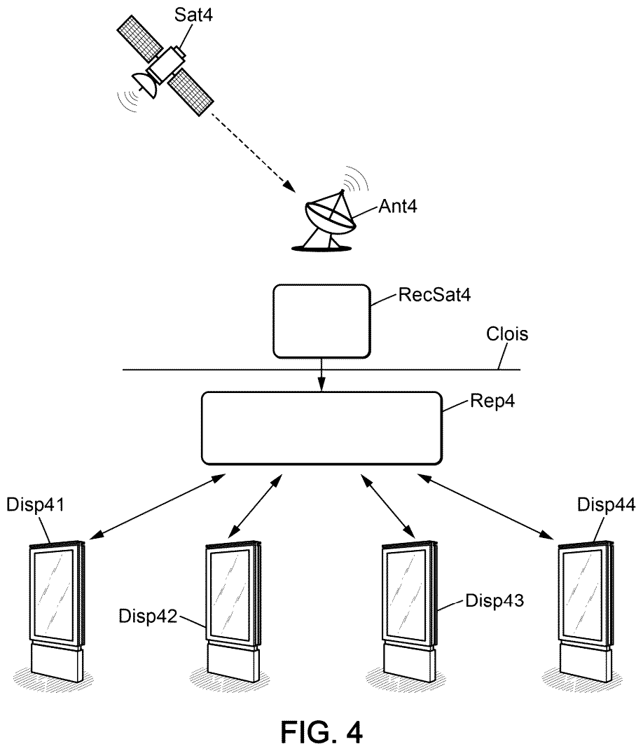

For example, the display device may be located inside a building (airport, train station, shopping center, etc.) and be in local connection (for example, by a local wired network such as ethernet, Bluetooth, Wi-Fi, etc.) with the satellite receiver located on the roof of the building, or generally in another nearby area where satellite signals may be received. An example of such an implementation will be described in more detail with reference to FIG. 4.

In that way, the display device may receive messages sent by satellite, even if it is located inside, or more generally in an area where it cannot receive satellite messages.

This makes it possible to benefit from a satellite connection even when the display device itself is located in a place blocking it from receiving satellite signals.

The second communication channel may also comprise a low-rate radio connection such as an SMS or Lora connection. These connections serve to send simple messages over long distances and very reliably, all while benefiting from an existing infrastructure and making it possible to send messages into zones not covered by the cellular network.

In the example from FIG. 3a, the switch Comm is a software module of the player Lec1. Stopping the broadcast of the first content, and the optional broadcast of a second content received via the second communication channel is therefore done directly in the first player Lec1 which makes a simple and flexible architecture possible.

The device Disp3a, the infrastructure Infra, and the platform Plat form a management system Sys3a for the display device Disp3a.

Now referring to FIG. 3b.

FIG. 3b shows a second example of a digital display device according to a set of embodiments of the invention.

The device Disp3b comprises, like the device Disp3a, at least one first receiver Rec1, at least one second receiver Rec2, at least one first player Lec1 and one second player Lec2. All the embodiments described with reference to device Disp3a and FIG. 3a are respectively applicable to device Disp3b, except for the incorporation of the switch Comm in the first player Lec1.

In contrast, in the device Disp3b, the switch Comm is distinct from the first player Lec1.

This serves to improve the security of the device Disp3b, because the switch Comm may then operate even in case of corruption of the first player Lec1.

In a set of embodiments of the invention, the device Disp3b may also comprise a second player able to play on the digital screen a message or second content associated with the message received by the second receiver. In this case, the switch is configured, not only for deactivating playing of the first content by the first player, but also for activating playing of the second content by the second player upon receiving the message, and thus displaying the second content.

This further reinforces the security of the device, because the second player Lec2 is independent of the first player Lec1 and may therefore operate even in case of corruption of the first player Lec1.

Further, the second player Lec2 may be specifically suited to the broadcast of stop or emergency messages. For example, all the functionalities of the player of the second content associated with the message discussed with reference to FIG. 3a, in particular playing a text content associated with the message, a video associated with the message, or the generation and playing of a video associated with the message, may be implemented within player Lec2.

As shown in FIG. 3b, the switch may be interposed between the first player Lec1, the second player Lec2, and the screen. Thus, the switch may activate or deactivate one of the two players, simply by selecting one of the inputs thereof to be sent to the screen.

The various elements of the device Disp3b, in particular the first player Lec1, the second player Lec2, the first receiver Rec1, the second receiver Rec2 and the switch Comm may be implemented differently.

For example, each of these elements may comprise software modules executed by one or more processing units.

In particular, the device Disp3b may comprise:
at least one first processing unit for implementing the first player Lec1 and the first receiver Rec1. A single first processing unit or plurality of first distinct processing units may be used for implementing the first player Lec1 and the first receiver Rec1;
at least one second processing unit, distinct from the at least one first processing unit, for implementing the second receiver Rec2 and the switch Comm. The at least one second processing unit may also implement the second player Lec2 in the embodiment of the invention where it is present. A single second processing unit, or a plurality of second distinct processing units may be used for implementing the first player Lec2, the second receiver Rec2 and the switch.

In that way, two processing units, or groups of distinct processing units, are used:
on one hand, for implementing the standard receiving and content broadcasting chain, which comprises the first receiver Rec1 and the first player Lec1;
on the other hand, for implementing the chain for stopping the broadcast of the first contact, and as applicable broadcasting the second content, comprising a switch Comm, the second receiver Rec2 and in some embodiments the second player Lec2.

This makes it possible to further improve the security of the device 3b, because the chain for stopping the broadcast of the first content, and when applicable for broadcasting the second content, continues to operate even in case of complete corruption of the chain for broadcasting the first content.

In a set of embodiments of the invention, the various elements composing the device Disp3b may be arranged in distinct material units, for example distinct boards or printed circuits, connected to each other by wire or network connections.

For example:
the at least one first receiver Rec1 may be connected to the first player Lec1 by a TCP/IP connection;
the first player Lec1 may be connected to the switch Comm by an HDMI connection;
the at least one second receiver Rec2 may be connected to the second player Lec2 by a serial port;
the second player Lec2 may be connected to the switch Comm by a serial port and an HDMI connection. The HDMI connection makes it possible to send the content to play, for example video content, from the second player Lec2 to the switch Comm. For its part, the serial port connection makes it possible for the player Lec2 to send the switch Comm the order to switch the source of the content played on the screen, from the player Lec1 to the player Lec2;
the switch Comm may be connected to the screen Ecr by an HDMI connection.

The device Disp3b, the infrastructure Infra, and the platform Plat form a management system Sys3b for the display device Disp3b.

It is now referred to FIG. 4.

FIG. 4 shows an example of receiving satellite signals by inside digital display devices, according to an embodiment of the invention.

As indicated above, a digital display device located in a zone that does not receive satellite signals (for example, inside) may in a set of embodiments of the invention receive messages sent by satellite via a satellite receiver with which it has a local connection.

In the example from FIG. 4, four digital display devices Disp41, Disp42, Disp43, Disp44 are located inside a building, and cannot receive messages sent by the satellite Sat4 because the signals sent by the satellite are blocked by the partition Clois, which may for example be a wall or ceiling of the building.

The digital display devices Disp41, Disp42, Disp43, and Disp44 may for example be located in an airport, train station or shopping center.

In this example, the building is equipped with an antenna Ant4 connected to a satellite signal receiver RecSat4 located outside of the building, for example on the roof. The receiver RecSat4 may thus freely receive the signals sent by the satellite Sat4.

The signals are then directed to the devices Disp41, Disp42, Disp43, and Disp44, for example through a repeater Rep4 connected to the receiver RecSat4. The repeater Rep4 may for example comprise a Wi-Fi router.

In that way, all the digital display devices Disp41, Disp42, Disp43, and Disp44 may receive messages, for example alert or emergency messages, by satellite, even if they are located inside and cannot directly receive signals sent by a satellite.

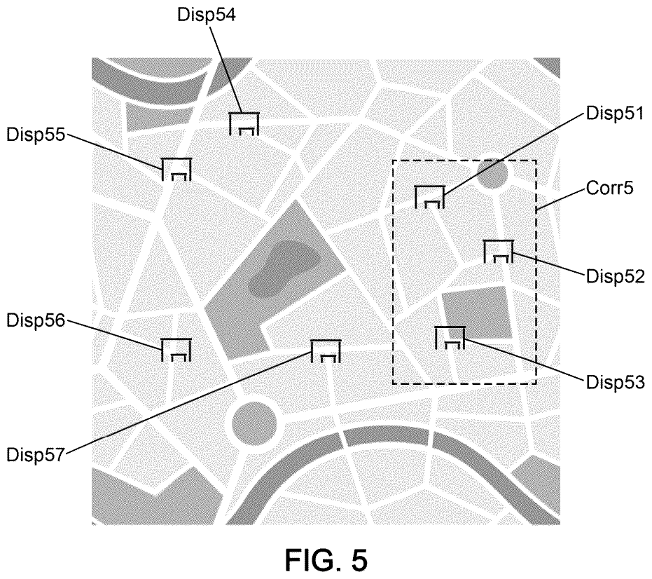

It is now referred to FIG. 5.

FIG. 5 shows an example of local detection of corrupted digital display devices, according to an embodiment.

More precisely, FIG. 5 shows a map of a city where seven digital display devices Dsp51, Disp52, Disp53, Disp54, Disp55, Disp56 and Dsp57 are shown (in reality, the number of digital display devices managed by an operator is much larger and may reach several tens or hundreds of thousands of digital display devices located in a multitude of sites, possibly distributed over several countries).

In the case where a localized corruption Corr5 of three devices Disp51, Disp52 and Disp53 is detected, a stop message may be selectively sent to the three devices Disp51, Disp52 and Disp53 in order to stop the broadcast of malicious content on these devices.

This example is however provided solely as a nonlimiting example of selectively sending messages to a subset of digital display devices. According to various embodiments of the invention, stop messages may be sent to digital display devices according to various criteria, when a subset of available devices is corrupted. For example, a message may be sent to:
all the display devices in a given zone;
all the devices having given technical characteristics (for example, a version number for which a security defect has been identified);
etc.

In all cases, a message may be sent simultaneously to the set of devices for which a corruption was detected, in order to simultaneously stop the display of malicious messages by the set of devices.

This example shows the capacity of a system for managing the display of digital display devices according to a set of embodiments of the invention to immediately stop the broadcast of malicious messages over all the devices affected by the corruption.

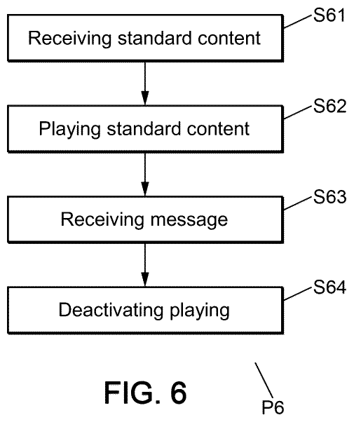

It is now referred to FIG. 6.

FIG. 6 shows a process P6 for control of a digital display device such as one of the devices Disp3a and Disp3b shown in FIGS. 3a and 3b.

The process P6 comprises a first step S61 of receiving, by at least one first receiver Rec1 of the device, at least one first content by a first communication channel.

It comprises a second step S62 of playing, by a first player Lec1 of the device, at least one first content on at least one digital screen Ecr of the device.

The process P6 then comprises a third step S63 of receiving, by at least one second receiver Rec2 of the device, at least one message by a second communication channel.

The process P6 finally comprises, upon receiving at least one message, a fourth step S64 of deactivating the device by a switch Comm, and playing the at least one first content by the first player.

All the embodiments discussed with reference to FIGS. 3a and 3b are respectively applicable to the method P6.

The present disclosure is not limited to the device, system, process and computer program examples described above only as examples, but it encompasses all variants which could be conceived by the person skilled in the art in the scope of the protection sought.

1. A digital display device comprising:
at least one digital screen;
at least one first receiver able to receive at least one first content via a first communication channel;
at least one second receiver, distinct from the at least one first receiver, able to receive at least one message via a second communication channel, distinct from the first communication channel;
a first player able to play on the at least one digital screen the at least one first content received via the first communication channel;
a switch configured for deactivating playing of the at least one first content by the first player, upon receiving a message via the at least one second receiver.

2. The device according to claim 1 comprising a second player able to display on the digital screen a message received by the at least one second receiver or a second content associated with the message received by the second receiver, and wherein the switch is configured for activating the playing by the second player upon receiving the message.

3. The device according to claim 1 comprising:
at least one first processing unit for implementing the first player and the first receiver;
at least one second processing unit, distinct from the at least one first processing unit, for implementing the second receiver and the switch.

4. The device according to claim 1, wherein the switch is a software module incorporated in the first player.

5. The device according to claim 1, wherein the first or second player is configured for playing a second content associated with the message.

6. The device according to claim 5, wherein the first or the second player is configured for converting a text content of the message into a video representing the content of the message, and playing the video on the screen.

7. The device according to claim 5, wherein:
the second receiver is configured for receiving the second content associated with the message;
and the first or second player is configured for playing the second content on the screen.

8. The device according to claim 1, wherein the first communication channel is a high-speed connection with an infrastructure of the operator of the display device, and the at least one first content comprises the video content.

9. The device according to claim 1, wherein the second communication channel comprises a long-distance radio connection.

10. The device according to claim 1, wherein the second receiver is in local communication with a satellite receiver.

11. The device according to claim 1, wherein the second communication channel comprises a low-rate radio connection.

12. The device according to claim 1, wherein the second communication channel is a communication channel with an emergency management platform configured for sending an emergency message to the second receiver via the second communication channel in case of a catastrophic event.

13. The device according to claim 1, wherein the second communication channel is a communication channel with a platform configured for sending a stop message to the second receiver via the second communication channel on detection of corruption of the display device.

14. The management system for a display device comprising:
the display device according to claim 1;
an infrastructure of the operator of the display device in communication with the display device via the first communication channel;
a platform, in communication with the display device via the second communication channel.

15. A process for control of a digital display device, comprising:
receiving, by at least one first receiver of the device, at least one first content via a first communication channel;
playing, by a first player of the device, at least one first content on at least one digital screen of the device;
receiving, by at least one second receiver of the device, distinct from the at least one first receiver, at least one message via a second communication channel, distinct from the first communication channel;
upon receiving the at least one message, deactivating by a switch of the device, the playing of the at least one first content by the first player.

16. The computer program comprising instructions for implementing the process according to claim 15 when this program is executed by a processor.

17. The nonvolatile, computer-readable recording medium on which is stored a program for use by the process according to claim 15 when this program is executed by a processor.
